(19) United States
(12) Patent Application Publication
(10) Pub. No.: US 2005/0023346 A1
(43) Pub. Date: Feb. 3, 2005

(54) System and method for providing incentives based on receipt sniffing

(75) Inventors: Anton Bakker, Norfolk, VA (US); Marc L. Allen, Chesapeake, VA (US)

Correspondence Address: NIXON PEABODY, LLP, 401 9TH STREET, NW, SUITE 900, WASHINGTON, DC, 20004-2128, US

(73) Assignee: Outsite Networks, Inc., Norfolk, VA (US)

(21) Appl. No.: 10/863,284

(22) Filed: Jun. 9, 2004

Related U.S. Application Data
(63) Continuation-in-part of application No. 10/428,046, filed on May 2, 2003.
(60) Provisional application No. 60/377,589, filed on May 6, 2002.

(51) Int. Cl. G06K 15/00; G06K 19/06

(52) U.S. Cl. 235/383

(57) ABSTRACT

A system and method for providing an incentive for a purchase, including monitoring communications between a purchase system and price displaying device to determine information regarding a transaction; identifying at least one item being purchased as part of the transaction from the transaction information; determining a loyalty reward based on the identified item being purchased; and dispensing the loyalty reward.

### CROSS-REFERENCE TO RELATED CASES

The present invention claims benefit of priority under 35 U.S.C. §119(e) to U.S. Provisional Patent Application Ser. No. 60/447,756, filed Jun. 12, 2003, entitled “Receipt Sniffing Incentives,” and is a Continuation-in-Part application of commonly-assigned, co-pending, U.S. patent application Ser. No. 10/428,046, filed May 2, 2003, entitled “Self-Contained Electronic Loyalty System,” which claims benefit of U.S. Provisional Patent Applications Ser. No. 60/377,589, filed May 6, 2002, entitled “Self Contained Electronic Loyalty System,” and which is related to U.S. patent application Ser. No. 10/137,375, filed May 3, 2002, entitled “Systems and Methods for the Identification and Displaying of Information,” and U.S. patent application Ser. No. 10/396,499, filed Mar. 26, 2003, entitled “Automatic Customer Acquisition in a Loyalty System,” the entire disclosures of all of which are hereby incorporated by reference herein.

### BACKGROUND OF THE INVENTION

1. Field of the Invention

This invention generally relates to loyalty systems, and more particularly to a system and method for providing incentives based on monitored data transmitted between a point-of-sale terminal and a price scanning or displaying device.

2. Discussion of the Background

Loyalty systems reward a customer for frequent use of a company's services, frequent purchasing of a company's goods, or the like. For example, frequent flyer miles are a prime example of how airlines reward passengers for traveling on their particular airline. The reward, based on a number of “miles” accumulated can vary from discounts on future airline tickets, to seat upgrades, to free tickets, or the like.

Loyalty systems are becoming more popular as a retail mechanism for obtaining, retaining and rewarding customers. Before employing a loyalty system, a retailer must decide if the benefits outweigh the costs. Loyalty systems have existed in many forms, from simple punch card applications to large-scale electronic systems designed to interface with, for example, grocery store systems.

However, current loyalty systems are generally price dependent and vary greatly in terms of their data gathering capabilities. For example, inexpensive systems typically use a manual entry device to enter specific data required to issue loyalty points or rewards. Such devices are typically limited to transaction or quantity totals, but provide little additional functionality. Furthermore, these systems are incapable of assisting the retailer in determining how well the actual loyalty system is performing, or which types of consumers are purchasing which types of products.

Alternative systems provide excellent data gathering capabilities, however they only operate in conjunction with a small set of, for example, point-of-sale register systems. Thus, retailers with multiple locations using different register systems, such as gas stations, are often unable to use a single loyalty system for all stations. For other systems, it is difficult to integrate the new loyalty system with perhaps older cash register or point-of-sale systems. Thus, it is not only necessary to purchase a loyalty system, but also a new cash register system to install many current loyalty systems.

### SUMMARY OF THE INVENTION

Therefore, there is a need for a method and system that addresses the above and other problems with a stand-alone loyalty system and method that can readily function with existing point-of-sale systems without incurring high cost in retrofitting the existing systems. The above and other needs are addressed by the exemplary embodiments of the present invention, which provide a system, method, and computer program product for a loyalty system based on receipt sniffing, wherein the exemplary systems and methods of this invention can be adapted to work in conjunction with existing loyalty systems, or as the basis of a new loyalty system. Specifically, the systems and methods provide a loyalty module that is retrofitted between a point-of-sale, cash register, or similar device, and the associated receipt printer. This allows the loyalty device to intercept information destined for printing at the receipt printer. With the receipt data, the loyalty module is able to determine which items have been purchased, the price of the item(s), purchaser information, payment type, and the like. Using this information, for example, loyalty points or rewards can be issued based on various parameters.

Accordingly, in an exemplary aspect of the present invention there is provided a method and system for providing an incentive for a purchase, including monitoring communications between a purchase system and price displaying device to determine information regarding a transaction; identifying at least one item being purchased as part of the transaction from the transaction information; determining a loyalty reward based on the identified item being purchased; and dispensing the loyalty reward.

Still other aspects, features, and advantages of the present invention are readily apparent from the following detailed description, by illustrating a number of exemplary embodiments and implementations, including the best mode contemplated for carrying out the present invention. The present invention is also capable of other and different embodiments, and its several details can be modified in various respects, all without departing from the spirit and scope of the present invention. Accordingly, the drawings and descriptions are to be regarded as illustrative in nature, and not as restrictive.

### BRIEF DESCRIPTION OF THE DRAWINGS

The embodiments of the present invention are illustrated by way of example, and not by way of limitation, in the figures of the accompanying drawings and in which like reference numerals refer to similar elements and in which:

FIG. 1 is a functional block diagram illustrating an exemplary loyalty system according to this invention;

FIG. 2 is a detailed functional block diagram of an exemplary tag according to this invention;

FIG. 3 is a detailed block diagram of an exemplary loyalty module according to this invention;

FIG. 4 is a flowchart illustrating the exemplary operation of the loyalty module according to this invention;

FIG. 5 is a functional block diagram illustrating the exemplary operation of a tag according to this invention;

FIG. 6 is a functional block diagram illustrating another embodiment of a loyalty system according to the present invention;

FIG. 7 is a detailed block diagram of an exemplary sniffer module according to the embodiment illustrated in FIG. 6; and

FIG. 8 is a functional block diagram illustrating the exemplary operation of a sniffer module in FIGS. 6 and 7.

### DETAILED DESCRIPTION OF THE PREFERRED EMBODIMENTS

The exemplary systems and the methods of this invention will be described in relation to a loyalty system. However, to avoid unnecessarily obscuring the present invention, the following description omits well-known structures and devices that may be shown in block diagram form or otherwise summarized. For the purpose of explanation, numerous specific details are set forth in order to provide a thorough understanding of the present invention. It should be appreciated however that the present invention may be practiced in a variety of ways beyond the specific details set forth herein. For example, the systems and methods of this invention can be scaled to any level and are capable of working in conjunction with various types of customer and already existing systems.

Furthermore, while the exemplary embodiments illustrated herein show the various components of the loyalty system collocated, it is to be appreciated that the various components of the system can be located at distant portions of a distributed network, such as a WAN and/or the Internet, or within a dedicated loyalty system. Thus, it should be appreciated that the components of the loyalty system can be combined into one or more devices or collocated on a particular node of a distributed network, such as a communications network. It will be appreciated from the following description, and for reasons of computational efficiency, that the components of the loyalty system can be arranged at any location within a distributed network without affecting the operation of the system.

Additionally, it should be appreciated that the various links connecting the elements can be wired or wireless links, or any combination thereof, or any other known or later developed element(s) that is capable of supplying and/or communicating data to and from the connected elements. Additionally, the term module as used herein can refer to any known or later developed hardware, software, or combination of hardware and software that is capable of performing the functionality associated with that element. Likewise, for example, to facilitate scaling of the system, one or more components of the loyalty system can be mirrored and supplemented with, for example, load sharing functionality if desired.

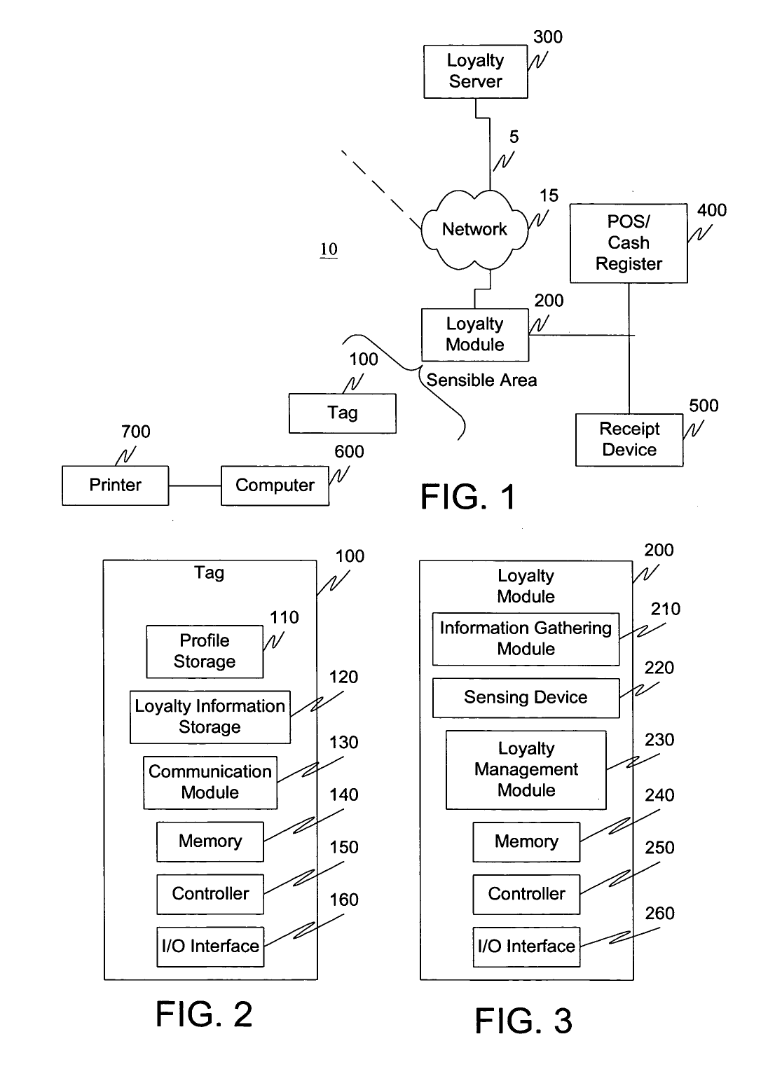

FIG. 1 illustrates an exemplary loyalty system 10. The loyalty system 10 comprises a tag 100, a loyalty module 200, a loyalty server 300, a point-of-sale device 400, such as a cash register and a receipt device 500, all interconnected by links 5 and optionally network 15. Furthermore, the loyalty system 10 can optionally include a computer 600 and printer 700.

In operation, the loyalty module 200 is adapted to monitor communications between the point-of-sale 400 and the receipt device 500. In particular, the loyalty module 200 can act in an active or passive fashion depending on, for example, rules specified in a profile associated with the tag 100 as discussed hereinafter. For example, in the passive mode, the loyalty module 200 can “listen” to communications between the point-of-sale 400 and the receipt device 500. Thus, the loyalty module 200 would at least have the information regarding the transaction that was passed to the receipt device 500. Based on this information, and a subsequent interaction with one or more of the tag 100 and the loyalty server 300, the loyalty module could allow the issuance of loyalty rewards based on this information.

Alternatively, in an active mode, the loyalty module 200 could intercept communications between the point-of-sale 400 and the receipt device 500. Then, based on an interaction with the tag 100, the loyalty module 200 could print one or more of a receipt, a loyalty reward, or the like at, for example, the receipt device 500.

Having the loyalty module 200 communicating with one or more of the point-of-sale 400 and the receipt device 500, the loyalty module 200 waits for a tag 100 to be placed in the sensible area of the loyalty module 200. For example, the loyalty module 200 can be equipped with an electrical, electromechanical, magnetic, inductive, capacitive, and/or optical detector, a credit card reader, a radio frequency identification (RFID) device, or in general any device that is capable of communicating and exchanging information with a comparably equipped readable/writable technology in the tag. This information can include, for example, profile information and loyalty information that is stored on the tag.

Thus, when the tag 100 is place in the sensible area of the loyalty module 200, the loyalty module can determine, based on the information in the tag in combination with current transaction information, if a loyalty reward is appropriate. If a loyalty reward is appropriate, the loyalty module 200 can cooperate with the tag 100 and update the loyalty information stored therein. Thus, it is not always necessary for the loyalty module 200 to communicate with the loyalty server 300 to be able to determine current loyalty rewards. While this communication is not precluded and, for example, based on information stored in a profile on the tag 100, this could be an alternative form of operation, it is not necessary.

For example, a profile stored on the tag 100 could specify that if the tag 100 is placed in the sensible area of the loyalty module 200, and a loyalty reward is appropriate, the profile could specify that information relating to the loyalty reward be forwarded to the loyalty server 300 and then, for example, e-mailed to an address specified in the profile. A user could then receive this loyalty information and, for example, print it out at their convenience. This would allow, for example, the loyalty module 200 to process loyalty rewards in a batch-processing type of environment, and thus could help eliminate communication bottlenecks that may occur over the network 15 and at the loyalty server 300. Alternatively, a tag reader/writer interface (not shown) could be connected to the computer 600 such that a user, upon receipt of the e-mail indicating a reward has been earned, could place the tag 100 in the sensible area of the tag reader/writer to update the tag with the reward information. This reward information could then be used, for example, for subsequent purchases at a point-of-sale 400.

Additionally, the profile may, for example, specify that transaction information should not be printed at the receipt device 500 at the time the transaction occurs, but rather stored in the tag and, for example, printed at a later time when the tag is placed in communication with the computer 600 and accompanying printer 700.

FIG. 2 illustrates in greater detail the components associated with the tag 100. In particular, the tag 100 comprises a profile storage 110, a loyalty information storage 120, a communication module 130, a memory 140, a controller 150 and an I/O interface 160. As well be appreciated, the tag 100 can further include a power source, such as a battery, rechargeable battery, solar panel, or the like, which are not shown but could also be included in the tag 100.

In operation, and upon being place in service, the tag 100 is initialized by, for example, establishing a profile in the profile storage 100. A “basic” or stock profile could be included in the profile storage 110 and upon receipt, through a user interface, such as a graphical user interface on a personal computer, PDA, or the like, a user would be able to customize the settings in the profile. Alternatively, the tag 100 can be shipped or given to a user with no profile thus allowing the user to completely configure and customize the profile based on their particular desires. As briefly discussed above, the profile could at least control how information associated with a current transaction is handled. For example, the following exemplary rules can be established that tailor the handling of information based on various factors.

Exemplary Profile A

1. Do not print receipts at receipt device
2. Store transaction information on tag
3. Send e-mail notification if reward earned
4. Use reward to pay or partially pay for transaction if reward available
   Exemplary Profile B
1. Print receipts at receipt device
2. Store transaction information on tag
3. Print coupon at receipt device if reward earned
4. Automatically transfer transaction information to financial management software when tag associated with computer
   Exemplary Profile C
1. Do not print receipts at receipt device
2. Do not store transaction information on tag
3. Print coupon at receipt device if reward earned
4. Use credit card information associated with tag to pay for transaction
   Exemplary Profile D

If at any gas station:
1. Do not print receipts at receipt device
2. Store transaction information on tag
3. Print coupon at receipt device if reward earned
4. Use credit card information associated with tag to pay for transaction
   Exemplary Profile E

If at store X:
1. Do not print receipts at receipt device
2. Store transaction information on tag
3. Print coupon at receipt device if reward earned
4. Use credit card information associated with tag to pay for transaction
5. Automatically transfer transaction information to financial management software when tag associated with computer

Associated with a profile is also an identifier that identifies a user associated with the tag 100. This identification can be shared with the loyalty server 300 such that when, for example, a profile specifies the handling of transaction information that includes the interaction of the loyalty server 300, the loyalty server 300 knows how to process the information based on the identification.

Loyalty information is stored in the loyalty information storage module 120. Specifically, when the tag 100 is placed in the sensible area of the loyalty module 200, and in cooperation with the communication module 130, the memory 140, the controller 150 and the I/O interface 160, the loyalty information storage is able to obtain information about a particular transaction that occurred at the point-of-sale 400. Then, based on information in the profile, the information regarding the transaction is processed in accordance with those rules. For example, the profile may specify that the transaction information is not to be printed on the receipt device 500, but rather stored in the loyalty information storage 120. For example, this information can include the time and date of the transaction, the store, the items purchased, the amount paid and/or any other information that could be available about the particular transaction. Furthermore, the stored transaction information can be maintained in the loyalty information storage 100 to facilitate the returning of items to a store by, for example, placing the tag 100 in the sensible area of the loyalty module 200 and specifying that a particular receipt(s) is to be printed. For example, to facilitate this type of activity, a user interface can be provided at a store that would allow the user to access information within the tag 100.

In addition to being capable of storing information regarding the current transaction, the loyalty module 200 is able to obtain historical transition information from the loyalty information storage 120 to aid in facilitating whether a loyalty reward is appropriate. For example, the loyalty information storage 120 may have various portions. One portion may store transaction information, another portion may store reward points, another portion frequent flyer miles, another portion user information, such as credit card number(s), and the like. By separating the various portions, a consumers information and consumers privacy can be protected. For example, there may be another rule in the profile storage 110 that specifies, for example, when the tag 100 is in communication with the loyalty module 200, only historical information relating to the particular store or, chain of stores, the user is currently at will be shared with the loyalty module 200.

Having determined whether any loyalty reward is appropriate, the loyalty module 200 can return to the tag 100, via the communication module 130, the memory 140, the controller 150 and the I/O interface 160, any updated loyalty reward information as appropriate. This loyalty reward information can then be stored in the loyalty information storage 120. Again, and for example as specified by the profile, a user can establish rules defining how the user is to be kept informed about loyalty information and how loyalty rewards will be process. For example, a new user could specify that when a loyalty reward is available, a light or audible sound (not shown) could be activated on one or more of the tag 100 and the loyalty module 200. This would notify the user that a reward is available and then allow, for example, the user to reintroduce the tag 100 into the sensible area 200 of the loyalty module and through this pattern of behavior direct the loyalty module 200 to print the loyalty reward at the receipt device 500. Alternatively, for example, a user may take the tag 100 to a location, such as a personal computer in the home, and “synchronize” the tag with the computer 600. This synchronization could be via a wired or wireless connection, such as a USB or optical connection. A user could then be presented with a user interface that would allow the user to interact with information in the tag 100 and, for example, specify various portions of information to be printed, such as earned loyalty rewards, transaction information, or the like. Furthermore, the user interface could allow the user to export transaction information stored on the tag into, for example, a banking program in order to facilitate, for example, maintaining for the consumers checking account.

The awarding of loyalty rewards can be governed by at least two mechanisms. First, triggering events, such as frequent flyer miles, dollars spent on purchases, or the like can be stored in the loyalty information storage 120. Thus, when the tag 100 is introduced into the sensible area of the loyalty module 200, the loyalty module 200 has all the necessary information to determine whether a loyalty reward is appropriate. Alternatively, the loyalty module 200 can communicate with a loyalty server 300, this loyalty server 300 could act as a central host system that would allow the uploading and gathering of data, such as consumer activity, number of transactions, transaction breakdown, loyalty points, were awards earned or redeemed, cash register activity, non-loyalty transaction information, and the like. The loyalty server 300 could also download new loyalty parameters, i.e., triggers, such as new or changed reward levels, specials, or the like to the loyalty module 200. Therefore, for example, since the loyalty information and trigger are stored on either the tag 100 or the loyalty module 200, real-time communication with the loyalty server 300 is not mandatory. Furthermore, by using the loyalty server 300, the store-centric limitations of previous systems are overcome. Additionally, the loyalty server 300 could at predetermined intervals forward updated “trigger” information to the loyalty module such that when the tag 100 is next placed in the sensible area of the loyalty module 200 the triggers on the tag could be updated. An indication of a successful update could then be forwarded back to the loyalty server 300 to, for example, aid with the monitoring of the status of the tags in service.

Furthermore, it should be appreciated that that the tag, itself, could contain programming, or a program configuration which limits the necessity for communicating with the loyalty server 300. This information could be above and beyond that which is discussed above in relation to triggering. For instance, rules regarding reward scheduling, e.g., when a reward is active, or rules governing combinations of items purchased (or not) in association with rewards or point issuance. In short, as technology improves, aside from periodically updating information in the loyalty module, the tag could also become the repository for additional functional rules and data. A more complex version of the tag could contain additional memory and processing logic which would not pass-through the communications to the printer, but would store the communications until a signal, for example, activated by a button, is received instruction all or a portion of the communications to be sent to the printer. Alternatively still, the dongle and printer could be replaced with a dedicated printer, or the printer optionally incorporated in to the tag, for example if the tag is adapted to work with or integrated within PDA.

Likewise, the above configuration at least allows the tag 100 to be used at a variety of locations, such as grocery stores, gas stations, retail stores, airlines, or the like, that may use the same loyalty program as well as at locations that are on different or may use multiple loyalty programs.

FIG. 3 illustrates an exemplary detailed view of the loyalty module 200. The loyalty module 200 comprises an information gathering module 210, a sensing device 220, a loyalty management module 230, a memory 240, a controller 250 and an I/O interface 260. The information gathering module 210 actively or passively intercepts or obtains, respectively, transaction information associated with a transaction at the point-of-sale 400. For example, as previously discussed, the type of interaction the loyalty module 200 may have with the transaction information could be depended on information stored in the profile associated with the tag 100. For example, the loyalty module 200 could, as a normal course of operation, intercept the transaction information and store it in the memory 240 prior to sending it to the receipt device 500. Then, upon having sensed the tag 100, process the transaction information accordingly. In this manor, paper could be saved in that unnecessary receipts are not printed and consumer information is protected.

For example, for passive operation, a “dongle” can be inserted such that the cable goes from the point-of-sale into the dongle and add another straight-through cable from the other side of the dongle to the printer. Thus, the original circuit can be maintained. Passive circuitry senses the communication signals and passes them to a third cable which is connected to the loyalty module. Power can optionally be provided from the loyalty module over the third cable, although it should be appreciated that power could be obtained from various printer signals or an external power supply, or the like.

The sensing device 220, in cooperation with the memory 240, controller 250 and I/O interface 260, communicates with the tag 100 when the tag 100 is placed in the sensible area of the loyalty module 200. For example, as previously discussed, the sensing device 220 can be based on an electrical, electromechanical, optical, inductive, capacitive, or other configuration that allows the communication of information between the tag and the loyalty module 200.

The loyalty management module 230 reconciles the transaction information with the loyalty information stored on the tag 100 and determines if a loyalty reward is appropriate. As previously discussed, the triggers that determine when a loyalty reward is appropriate can be received from one or more of the loyalty server 300 and the tag 100.

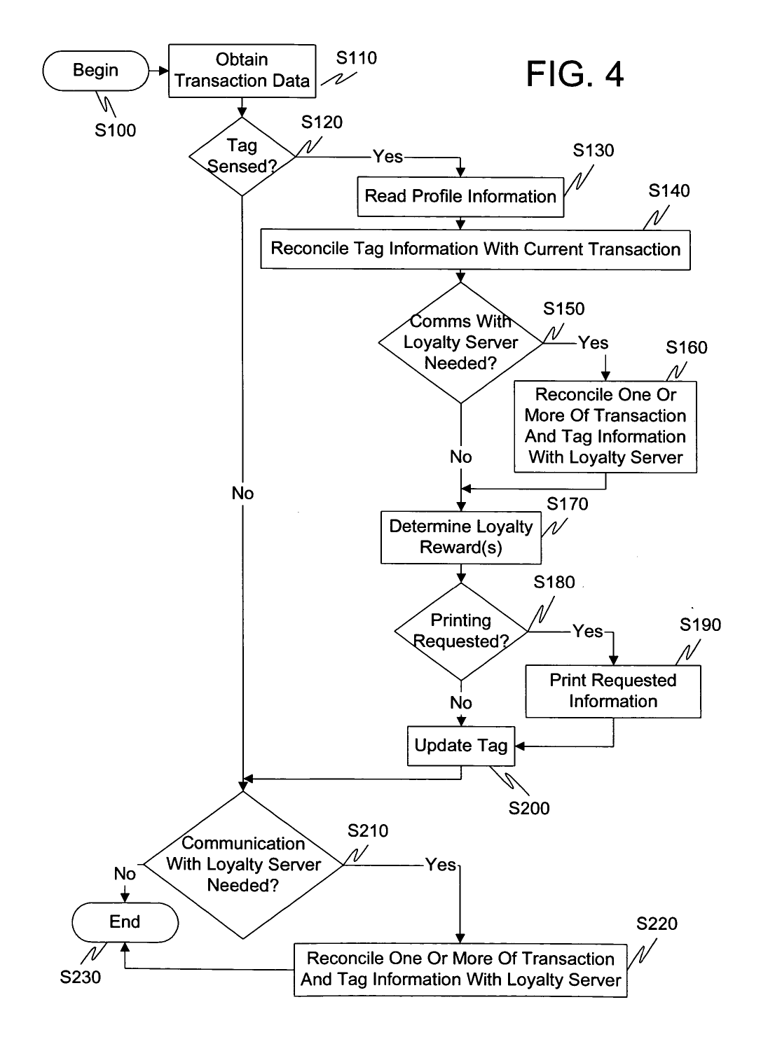

FIG. 4 outlines the exemplary operation of the loyalty system. In particular, control begins at step S100 and continues to step S110. In step S110, transaction data is obtained. Next, in step S120, a determination is made whether a tag has been placed in the sensible area. If the tag has been sensed, control continues to step S130. Otherwise, control jumps to step 590.

In step S130, profile information is read from the tag. Next, in step S140, the tag information is reconciled with current transaction information. Then, in step S150, the loyalty system optionally determines if communications with the loyalty server are needed. If communications are needed, control continues to step S160 where one or more of transaction and tag information are reconciled with the loyalty server. Otherwise, control jumps to step S170.

In step S170, a determination is made whether any loyalty rewards have been earned. Control then continues to step S160.

In step S180 a determination is made whether printing is requested. If printing is requested, control continues to step S190 where the requested information is print. Otherwise, control jumps to step S200. In step S200, the tag is updated with any appropriate transaction information and/or loyalty rewards as appropriate. Control then continues to step S210.

In step S210, a determination is made whether a communication with the loyalty server is needed. If a communication with the loyalty server is needed, control continues to step S220. Otherwise, control jumps to step S230 where the control sequence ends.

In step S220, one ore more of transaction, tag information and loyalty reward information is reconciled, sent to or received from the loyalty server as appropriate. Control then continues to step S230 where the control sequence ends.

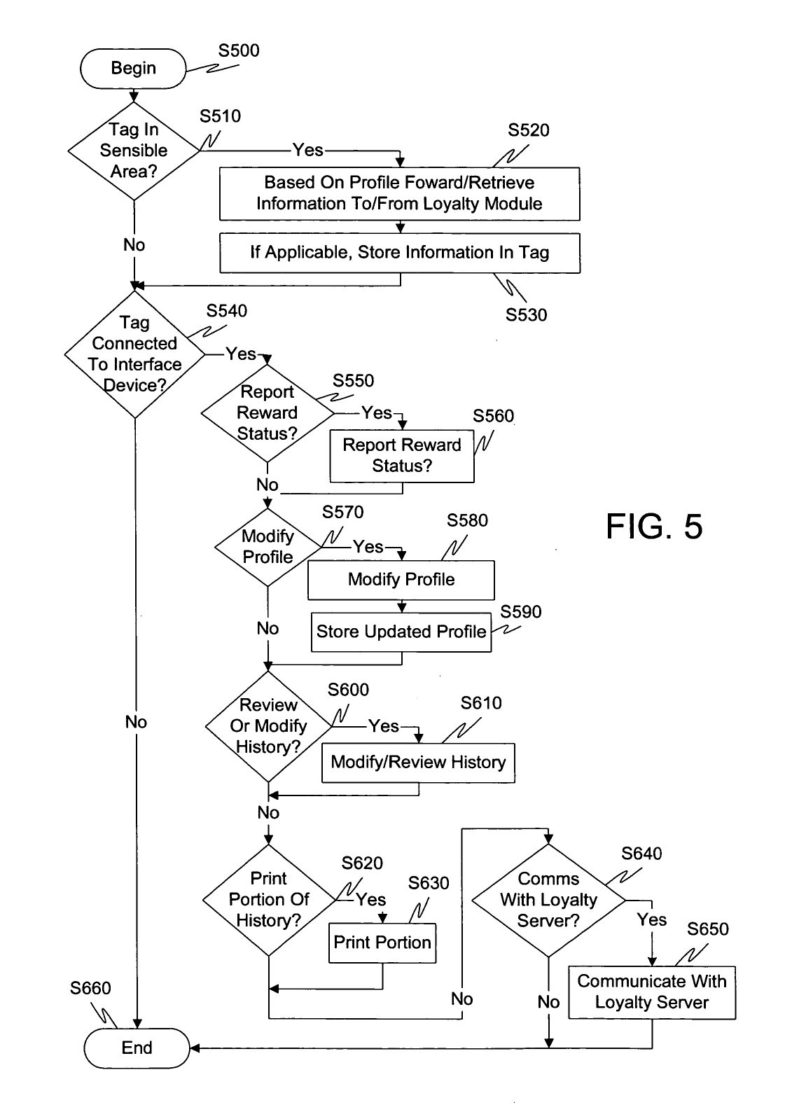

FIG. 5 outlines the exemplary operation of a tag. In particular, control begins in step S500 and continues to step S510. In step S510, a determination is made whether the tag has been introduced into the sensible area of the loyalty module. If the tag is in the sensible area control continues to step S520. Otherwise, control jumps to step S540.

In step S520, and based on the profile, various information is forwarded to and/or received from the loyalty module. For example, as previously discussed, instructions for processing transaction data, how to process loyalty rewards, and historical information can be exchanged between the loyalty module and the tag. Then, if necessary, in step S530 the tag is updated with any appropriate information. Control then continues to step S540.

In step S540, a determination is made whether the tag has been connected to an interface device, such as a computer. If the tag is connected to an interface device, control continues to step S550. Otherwise, control jumps to step S640 where the control sequence ends.

In step S550, a determination is made whether a loyalty reward status report is requested. If a loyalty reward status report is requested, control continues to step S560 where the loyalty reward report is created. Control then continues to step S570.

In step S570, a determination is made whether the profile is to be modified. If the profile is to be modified, control jumps to step S580. Otherwise, control jumps to step S600.

In step S580, the profile is modified. Then, in step S590, the updated profile is stored. Control then continues to step S600.

In step S600, a determination is made whether to review and/or modify transaction history information. If a review or modification of the history information is required, control continues to step S610. Otherwise, control jumps to step S620.

In step S610, the user is allowed to modify and/or review history information via, for example, a user interface as discussed above. Control then continues to step S620.

In step S620, a determination is made whether a portion of the history is to be printed. If a portion of the history is to be printed control continues to step S630 where the portion is printed. Otherwise, control jumps to step S640.

In step S640, a determination is made if a communication with the loyalty server is needed. If communication with the loyalty server, is needed, control continues to step S650. Otherwise, control jumps to step S660 where the control sequence ends.

In step S650, the tag, via the interface device, communicates with the loyalty device to, for example, backup changes, provide additional information, store updated profile information, or the like. Control then continues to step S660 where the control sequence ends.

Thus, according to the exemplary embodiments, a consumer can receive earned points or rewards, if any, by simply associating a tag with the loyalty module. The loyalty module is capable of reading consumer information from the tag, such as current loyalty points status, earned rewards, and a consumer identification. The loyalty module is then able to store updated status reward information on the tag. The loyalty module is also able to issue loyalty rewards in the form of printed data, such as coupons or receipts, by sending data to either the cash register printer or another printer. The exemplary embodiments provide the ability for storing a plurality of types of information on a tag that allows a loyalty system, based on the information, to determine various rewards and/or points. Further, the exemplary embodiments include providing a tag that is capable of storing transaction information, and providing a tag that is modifiable and accessible to manage transaction information and loyalty information stored therein.

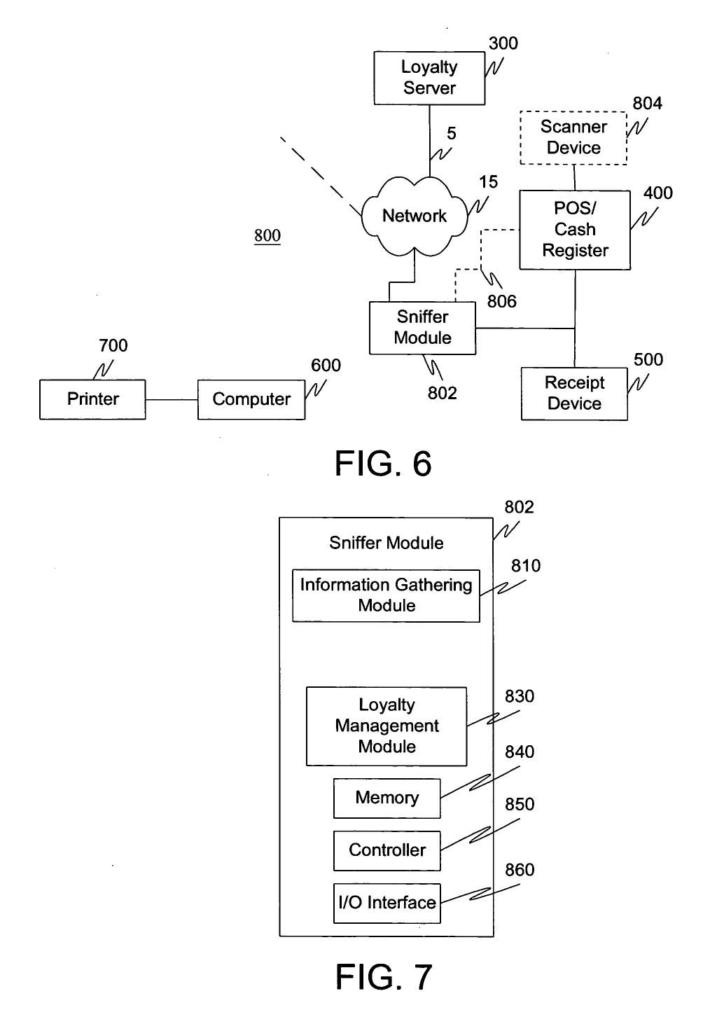

Accordingly, as described, in the system of FIG. 1, loyalty module 200 works in conjunction with tag 100, which contains consumer information from the tag, and other associated modules to execute the aforementioned processes. However, to achieve greater flexibility, affordability, and simplicity, the loyalty system 10 in FIG. 1 may be implemented without the loyalty module 200 and tag 100. An exemplary alternative embodiment to loyalty system 10 in FIG. 1 is shown as loyalty system 800 in FIG. 6. For the sake of brevity and clarity, the similar features shared by both embodiments illustrated in FIGS. 1 and 6 are shown with same numerical labels, and their descriptions are not repeated hereafter.

In FIG. 6, loyalty system 800 is shown with sniffer module 802 and with no ability to sense a tag containing consumer information. The sniffer module 802 operates in similar manner as loyalty module 200 in FIG. 1 in that the sniffer module 802 is interposed between, for example, a cash register or point of sale system 400, and a receipt printer 500. As such, the sniffer module 802 is adapted to actively or passively monitor information passed between the cash register or point of sale system 400 and the receipt printer 500. The information can be, for example, item information, purchaser information, store information, time and date information, or any other information that could be used by a loyalty system to assist in determining if a loyalty reward has been earned. The receipt printer 500 can be a traditional receipt printer, or an electronic device that, for example, stores electronic receipt information for the consumer.

FIG. 7 illustrates an exemplary detailed view of the sniffer module 802. In FIG. 7, the sniffer module 802 comprises an information gathering module 810, a loyalty management module 830, a memory 840, a controller 850 and an I/O interface 860. The information gathering module 810 actively or passively intercepts or obtains, respectively, transaction information between the point-of-sale system 400 and the receipt printer 500 and associated with a transaction the point-of-sale system 400.

In an active mode of operation, the sniffer module 802, in a normal course of operation, intercepts the transaction information and stores it in the memory 840 prior to sending it to the receipt device 500. In a passive operation, a “dongle” can be inserted, such that the cable goes from the point-of-sale system 400 into the dongle and another straight-through cable is added from the other side of the dongle to the receipt printer. 500. Thus, the original circuit, advantageously, can be maintained with this embodiment. Appropriately configured circuitry senses the communication signals and passes them to a third cable which is connected to the sniffer module 802. Power can optionally be provided from the sniffer module 802 over the third cable, although it should be appreciated that power could be obtained from various printer signals or an external power supply, or the like.

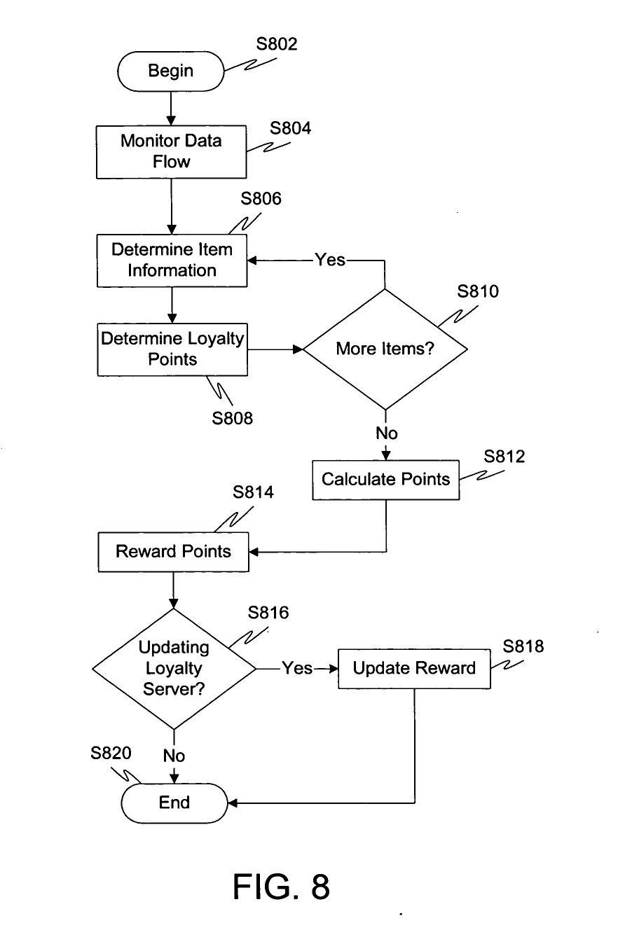

FIG. 8 outlines an exemplary operation of the loyalty system 800, particularly the sniffer module 802. In particular, controls begins at step S802 and continues to step S804. In step S804, data flow between, for example, an POS device or cash register 400 and a receipt device 500, as shown in FIG. 6, are monitored. Next, in step S806, the monitored data is analyzed for specific information, such as, for example, a time and date of a transaction, a retailer's identification and location, an item being purchased, an item's price and quantity, or the like. The date, time and retailer's location information, advantageously, can be employed to promote “happy hours” to attract business during off-peak days and times.

Based on the analyzed data, loyalty points are dynamically determined in step S808. If there are more items to be monitored, as determined in step S810, steps 806 and 808 can be repeated until there are no more item being purchased. For example, when a total is calculated by the POS device, the loyalty point determination can be stopped and the total number of loyal points can be calculated in step S812. After the total number of loyalty points earned are calculated, at step S814, the sniffer module 802 transmits the appropriate information to an associated device for dispensing a reward based on the number of loyalty points earned for immediate consumption or records the loyalty point information on a media to be given to the consumer.

Next, in step S816, the control determines whether or not to update the loyalty server 300 with information related to the current transaction. If the loyalty server 300 is available and reconcilation is desired, the sniffer module 802 transmits the transaction information to the loyalty server 300. If reconciliation with the loyalty server 300 is not possible or desirable, the control ends at step S820. Reconciling the loyalty server 300 with transaction data can be used for collecting customers' purchase history, buying habits, or the like, advantageously, which can be used, for example, to determine future marketing of merchandises.

In contrast with the loyalty system 10 in FIG. 1, the loyalty system 800 in FIG. 6 is free from the requirement of a consumer tag and the sensing of the tag to determine the information related to the consumer and the loyalty reward to be given. Hence, the cost of implementing and maintaining the loyalty system, including administering the tags, can be greatly reduced, and the capability of the loyalty system can be tailored to the specific need of each retailer. Further, the loyalty system 800 allows purchase data to be collected and analyzed without requiring customers to register for tags and sharing private information.

Advantageously, the above-described exemplary embodiments increase the flexibility, affordability, and simplicity of the loyalty system, wherein no information tag is necessary for determining loyalty points to be rewarded. The exemplary embodiments provide the ability, for example, to gather purchase information and dispense loyalty reward without requiring customers to have a tag and, hence, increases customers' privacy and reduces the cost of the system by, for example, eliminating the administering of tags to customers and maintaining the tags. Aspects of the invention also related to providing a self contained electronic loyalty system. Accordingly, the exemplary embodiments include a loyalty system that can be retrofitted with a purchase system having a price-displaying device for monitoring communication between the purchase system and the price-displaying device, determining loyalty rewards and dispensing rewards without using a tag containing consumer information, a loyalty system comprising a sniffer module that intercepts data traffic between a point-of-sale terminal and a receipt printing device or a price display device, a loyalty system comprising a sniffer module that intercepts data traffic between a check-out register and a price scanning device, a loyalty system comprising a sniffer module that intercepts data traffic between a point-of-sale terminal and a journal printer, or the like.

The above-described systems and methods can be implemented on a loyalty system, marketing system, advertising system, or the like, or on a separate programmed general purpose computer having loyalty capabilities. Additionally, the systems and methods of this invention can be implemented on a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device such as PLD, PLA, FPGA, PAL, stored as instructions on a recordable media, or the like. In general, any device capable of implementing a state machine that is in turn capable of implementing the flowcharts illustrated herein can be used to implement the system according to this invention.

Furthermore, the disclosed methods may be readily implemented in software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this invention is dependent on the speed and/or efficiency requirements of the system, the particular function, and the particular software or hardware systems or microprocessor or microcomputer systems being utilized. The systems and methods illustrated herein however can be readily implemented in hardware and/or software using any known or later developed systems or structures, devices and/or software by those of ordinary skill in the applicable art from the functional description provided herein and with a general basic knowledge of the computer and loyalty system arts.

Moreover, the disclosed methods may be readily implemented in software executed on programmed general purpose computer, a special purpose computer, a microprocessor, or the like. In these instances, the systems and methods of this invention can be implemented as program embedded on personal computer such as JAVA™. or CGI script, as a resource residing on a server or graphics workstation, as a routine embedded in a loyalty system, or the like. The system can also be implemented by physically incorporating the system and method into a software and/or hardware system, such as the hardware and software systems of a loyalty reward system.

While the present invention has been described in connection with a number of exemplary embodiments and implementations, the present invention is not so limited but rather covers various modifications and equivalent arrangements, which fall within the purview of the appended claims.

1. A method of for providing an incentive for a purchase, comprising:
monitoring communications between a purchase system and price displaying device to determine information regarding a transaction;
identifying at least one item being purchased as part of the transaction from the transaction information;
determining a loyalty reward based on the identified item being purchased; and
dispensing the loyalty reward.

2. The method of claim 1, wherein identifying step comprises determining the price of the item being purchased.

3. The method of claim 1, wherein identifying step includes determining the quantity of the item being purchased.

4. The method of claim 1, wherein monitoring step comprises determining date and time of the transaction from the transaction information, and the method further comprises determining the loyalty reward based on the determined date and time of the transaction.

5. The method of claim 1, wherein the purchase system and the price displaying device comprise a point-of-sale terminal and a receipt printing device, respectively.

6. The method of claim 1, wherein the purchase system and the price displaying device comprise a price scanner and check-out register, respectively.

7. The method of claim 1, wherein the purchase system and the price displaying device comprise a point-of-sale terminal and a journal printer, respectively.

8. A system for providing an incentive for a purchase, comprising:
means for monitoring communications between a purchase system and price displaying device to determine information regarding a transaction;
means for identifying at least one item being purchased as part of the transaction from the transaction information;
means for determining a loyalty reward based on the identified item being purchased; and
means dispensing the loyalty reward.

9. The system of claim 8, wherein the means for identifying comprises means for determining the price of the item being purchased.

10. The system of claim 8, wherein the means for identifying comprises means for determining the quantity of the item being purchased.

11. The system of claim 8, wherein the means for monitoring comprises means for monitoring date and time of the transaction from the transaction information, and the system further comprises means for determining the loyalty reward based on the determined date and time of the transaction.

12. The system of claim 8, wherein the purchase system and the price displaying device comprise a point-of-sale terminal and a receipt printing device, respectively.

13. The system of claim 8, wherein the purchase system and the price displaying device comprise a price scanner and check-out register, respectively.

14. The system of claim 8, wherein the purchase system and the price displaying device comprise a point-of-sale terminal and a journal printer, respectively.

15. The system of claim 8, wherein the monitoring means, the means for identifying at least one item being purchased, means for a loyalty reward and means for dispensing the reward comprise devices of a computer system.

16. The system of claim 8, wherein the monitoring means, the means for identifying at least one item being purchased, means for a loyalty reward and means for dispensing the reward comprise computer-readable instructions stored on a computer-readable medium.
